(19) United States
(12) Patent Application Publication
(10) Pub. No.: US 2007/0205962 A1
(43) Pub. Date: Sep. 6, 2007

(54) Wirelessly controlled display system and display media server

(75) Inventor: Ronald Lee Thompson, Knoxville, TN (US)

Correspondence Address: MARTIN J. MORAN, ESQ.;Eaton Electrical, Inc., Technology & Quality Center, 170 Industry Drive, RIDC Park West, Pittsburgh, PA, 15275-1032, US

(73) Assignee: EATON CORPORATION

(21) Appl. No.: 11/360,972

(22) Filed: Feb. 23, 2006

(51) Int. Cl. G09G 5/00

(52) U.S. Cl. 345/2.3; 345/169; 348/734; 340/825.69

(57) ABSTRACT

A display system includes a number of display blocks and a control device. At least one of the display blocks includes a shell structured to define an open region, a controller with a wireless transceiver structured to receive control information, and an output device structured to be turned on and off by the controller in response to the control information, wherein at least one of the controller and the output device is located within the open region. The control device has a wireless transceiver structured to communicate the control information to the wireless transceiver of the controller.

### BACKGROUND OF THE INVENTION

1. Field of the Invention

The present invention relates generally to display systems and, more particularly, to wirelessly controlled display systems. The invention also relates to servers for display systems.

2. Background Information

Traditional static displays (e.g., fiberboard collapsible displays; photographic display panels) are employed for a variety of purposes in diverse environments. Static displays may be used, for example, to market a vendor's product line at a trade show, to draw attention to specific merchandise in a department store, to provide information about a certain exhibit in a museum, and to promote the favorable attributes of a company within a building's lobby.

Traditional static displays, however, often fail to attract the attention of their targeted audience. This is especially true in instances where multiple static displays are employed and/or where the targeted audience is confronted with other distractions. In a trade show environment, for instance, where dozens of static displays are clustered together, individual static displays tend to blur together, becoming just another part of the background clutter. As a result, the attention of the targeted audience may not be drawn to the specific display as desired.

To combat this problem and increase their distinctiveness, many traditional static displays are custom-made for a specific venue. As a result, these displays have become cumbersome to transport and difficult to assemble/disassemble. This is especially inconvenient where the display is intended to be used in multiple locations (e.g., in different exhibit halls throughout a company's sales territory).

Thus, a need exists for an improved display system which eliminates these and other problems.

There is also a need for new and improved components of display systems.

### SUMMARY OF THE INVENTION

These needs and others are met by the present invention, which is directed to a display system comprising a number of display blocks and a control device. At least one of the display blocks comprises a shell structured to define an open region, a controller with a wireless transceiver structured to receive control information, and an output device structured to be turned on and off by the controller in response to the control information, wherein at least one of the controller and the output device is located within the open region. The control device has a wireless transceiver structured to communicate the control information to the wireless transceiver of the controller.

As another aspect of the invention, a display system comprises a number of input devices, a server, and a number of controllers. The input devices are structured to generate input information, each of at least some of the input devices is associated with an input module which includes a transceiver structured to wirelessly communicate the input information. The server, which includes a transceiver, is structured to receive the input information, to execute a number of routines for generating output information, and to wirelessly communicate the output information, wherein the output information includes audio/video information produced by execution of an audio/video routine and control information produced by execution of a wireless communication routine. The controllers are structured to turn on and off a number of output devices, each of at least some of the controllers is associated with an output module and includes a transceiver structured to wirelessly receive the control information.

As another aspect of the invention, a display media server comprises a storage apparatus having a number of routines stored therein, a processor structured to execute at least some of the routines and produce output information in response to a user input, the output information including audio/video information produced by execution of an audio/video routine and control information produced by execution of a wireless communication routine, and a transceiver structured to wirelessly communicate the output information including the audio/video information and the control information to a number of output devices.

As another aspect of the invention, a display system comprises a number of display blocks, a control device, and an input device. At least one of the display blocks comprises a shell structured to define an open region, a controller with a wireless transceiver structured to receive control information, and an output device structured to be turned on and off by the controller in response to the control information, wherein at least one of the controller and the output device is located within the open region. The control device has a wireless transceiver structured to communicate the control information to the wireless transceiver of the controller. The input device is associated with another controller with another wireless transceiver structured to communicate input information to the wireless transceiver of the control device.

### BRIEF DESCRIPTION OF THE DRAWINGS

A full understanding of the invention can be gained from the following description of the preferred embodiments when read in conjunction with the accompanying drawings in which:

FIG. 1 is a block diagram in schematic form of a display system according to one embodiment of the present invention.

FIG. 2 is an isometric view of a display block of FIG. 1 according to one embodiment of the invention.

FIG. 3 is an isometric view of the display block of FIG. 1 according to another embodiment of the invention.

FIG. 4 is a block diagram in schematic form of the display system of FIG. 1 according to one embodiment of the present invention.

FIG. 5 is a block diagram in schematic form of the display system of FIG. 4 according to an embodiment of the present invention.

FIG. 6 is a block diagram in schematic form of the server for the display system of FIG. 5 according to one embodiment of the present invention.

FIG. 7 is a block diagram in schematic form of a control device for the display system of FIG. 4 according to another embodiment of the present invention.

FIGS. 8a-8i are simplified vertical elevation views illustrating different array arrangements of the display blocks of the display system of FIG. 1.

### DESCRIPTION OF THE PREFERRED EMBODIMENTS

Directional phrases used herein, such as, for example, left, right, clockwise, counterclockwise, top, bottom, up, down, and derivatives thereof, relate to the orientation of the elements shown in the drawings and are not limiting upon the claims unless expressly recited therein.

As employed herein, the term “number” shall mean one or more than one and the singular form of “a”, “an”, and “the” include plural referents unless the context clearly indicates otherwise.

As employed herein, the statement that two or more parts are “connected” or “coupled” together shall mean that the parts are joined together either directly or joined together through one or more intermediate parts. Further, as employed herein, the statement that two or more parts are “attached” shall mean that the parts are joined together directly.

As employed herein, the term “wireless” shall expressly include, but not be limited by, radio frequency (RF), infrared, IrDA, wireless area networks, IEEE 802.11 (e.g., 802.11a; 802.11b; 802.11g), IEEE 802.15 (e.g., 802.15.1; 802.15.3, 802.15.4), other wireless communication standards (e.g., without limitation, ZigBee™ Alliance standard, DECT, PWT, pager, PCS, Wi-Fi, Bluetooth™, and cellular).

As employed herein, the term “communication network” shall expressly include, but not be limited by, any local area network (LAN), wide area network (WAN), intranet, extranet, global communication network, the Internet, and/or wireless communication network. An example of communication network is disclosed by U.S. Patent Application Publication No. 2005/0086366, which is incorporated herein by reference. Another example of a communication network is disclosed by U.S. Patent Application Publication No. 2005/0262519, which is incorporated herein by reference.

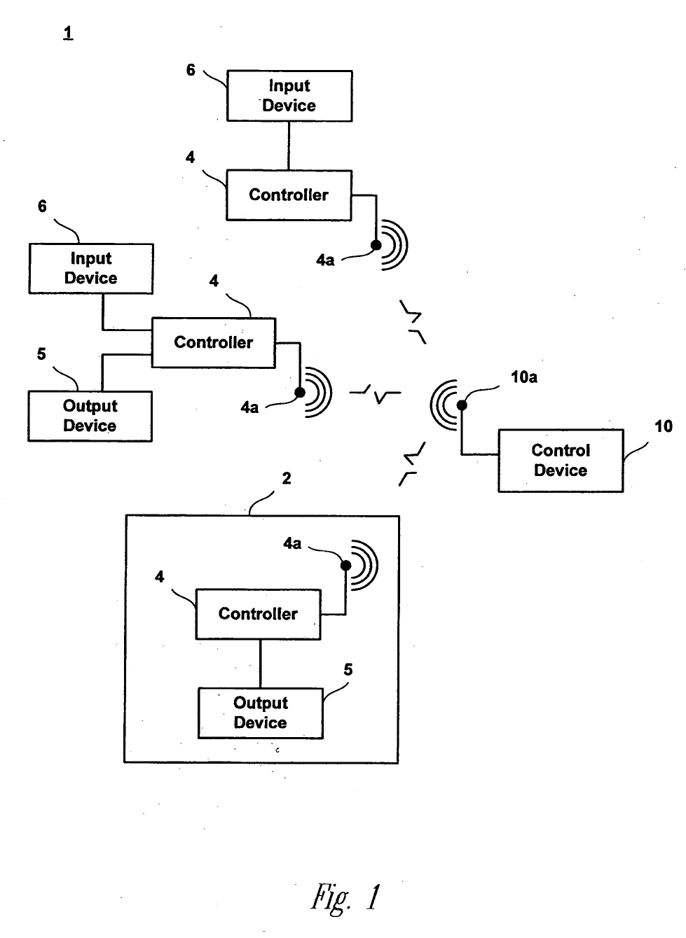

Referring to FIG. 1, a display system 1 utilizes embedded wireless technology to provide enhanced features which are not offered by known traditional static displays. For example, by adding (without limitation) wireless modules, controlled lighting, and other wireless devices, all of which may be controlled through configuration software, the display system 1 may be employed to dynamically interface with a targeted audience. Interactive audio/video servers may also be integrated into the display system to further enhance its dynamic qualities. The display system 1 may be part of a communication network.

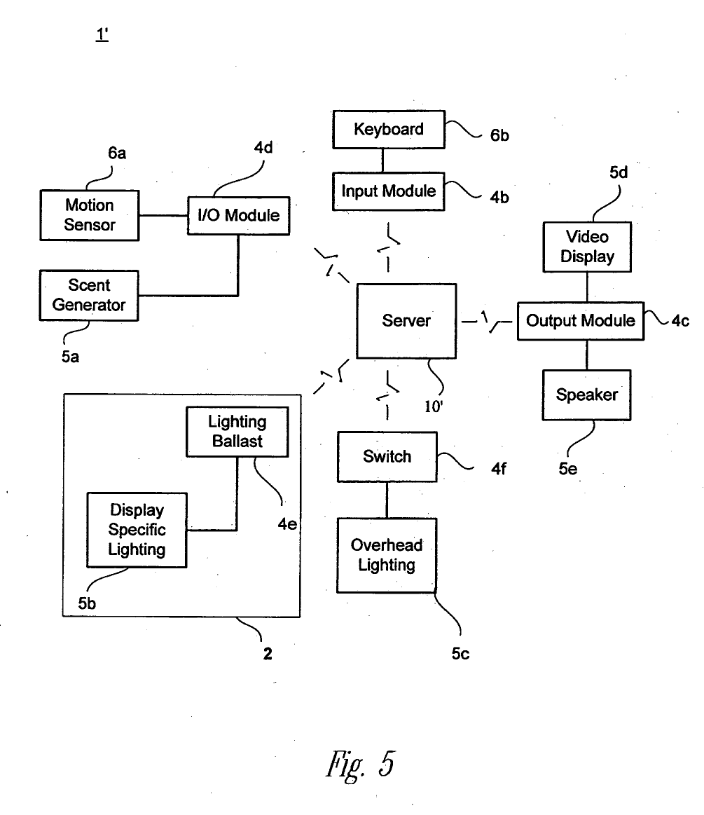

The display system 1 of FIG. 1 includes a control device 10 and a number of display blocks 2, at least one of which includes a controller 4 and an output device 5. The output device 5 may include, for example and without limitation, a light source, a scent generator, a thermostat, a motor, a video display, a speaker, and a projector. The display system 1 may also include an input device 6 and/or other portable wireless communicating device. An input device 6 may include, for example and without limitation, a motion sensor 6a (FIG. 5), a keyboard 6b (FIG. 5), a mouse, a biometric reader, a microphone, a camera, a vibration sensor, or any suitable sensor.

As will be discussed in more detail below, the input devices 6 wirelessly communicate input information to the control device 10. The control device 10 uses the input information, as well as other information, to produce output information. The output information may, for example and without limitation, contain control information and/or audio/video information. The control device 10 wirelessly communicates the output information to the controllers 4, which in response to control information contained therein, may cause the output devices 5 (and/or the input devices 6) to operate in a specific manner.

The output devices 5 and the input devices 6 may be indirectly controlled by an associated controller 4 (i.e., the output devices 5 and the input devices 6 do not need to independently possess wireless communication capability). For example, a light source 5c (FIG. 5) is indirectly activated/deactivated by a controller (e.g., switch 4f; FIG. 5) to which the light source's lighting ballast is connected. Alternatively, it is contemplated that the functions of an output device 5 and/or an input device 6 may be combined with the functions of a controller 4 within a single device. For example, a light source 5b (FIG. 5) may be directly activated/deactivated by a lighting ballast 4e (FIG. 5) which implements the functions of a controller 4 (i.e., which independently possesses wireless communication capability).

The control device 10 may be referred to as a network coordinator (NC). As employed herein, the term “network coordinator”, shall expressly include, but not be limited by, any communicating device, which operates as the coordinator for devices wanting to join a communication network and/or as a central controller in a wireless communication network.

The controllers 4 (along with any output devices 5 and any input devices 6 which independently possesses wireless communication capability) may be referred to as network devices. As employed herein, the term “network device” shall expressly include, but not be limited by, any communicating device, which participates in a wireless communication network, and which is not a network coordinator.

Network devices may be, for example and without limitation, an input device; an output device, a portable wireless communicating device; a camera/sensor device; a wireless camera; a control device; and/or a fixed wireless communicating device, such as, for example, switch sensors, motion sensors, or temperature sensors as employed in a wirelessly enabled sensor network. As employed herein, the term “portable wireless communicating device” shall expressly include, but not be limited by, any portable communicating device having a wireless communication port (e.g., without limitation, a portable wireless device; a portable personal computer (PC); a Personal Digital Assistant (PDA); a data phone).

In the current embodiment, the network coordinator (e.g., the control device 10) and the network devices (e.g., controller 4; a stand-alone input device; a stand-alone output device) communicate with each other using embedded wireless technology. More specifically, as shown in FIG. 1, the control device 10 has a wireless transceiver 10a and each controller 4 has a wireless transceiver 4a. The control device 10 (via wireless transceiver 10a) is structured to communicate with each controller 4 (via wireless transceiver 4a) using this wireless technology. Each controller 4 (via wireless transceiver 4a) may be structured to directly communicate with each other and/or be structured to indirectly communicate with each other through control device 10 (via wireless transceiver 10a) using this wireless technology. Alternatively, communications may be between the wireless transceiver 10a of: (1) control device 10 and the controller 4 of an input device 6; and (2) control device 10 and the controller 4 of output device 5.

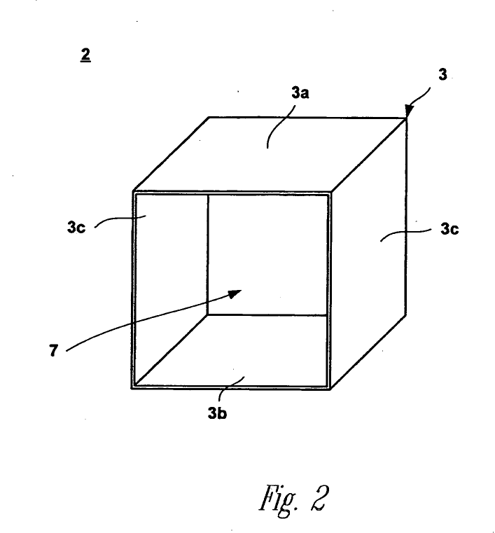

As mentioned above, the display system 1 includes a number of display blocks 2, at least one of which includes a controller 4 and an output device 5. A display block 2, according to one embodiment of the present invention, is illustrated in FIG. 2. The display block 2 includes a metal shell 3 having a first panel 3a, a second panel 3b, and a number of third panels 3c that couple the first panel 3a to the second panel 3b. An open region 7 is defined between the first panel 3a, the second panel 3b, and the third panels 3c. Although the example shell 3 is constructed of metal, it should be noted that any suitable material may be used.

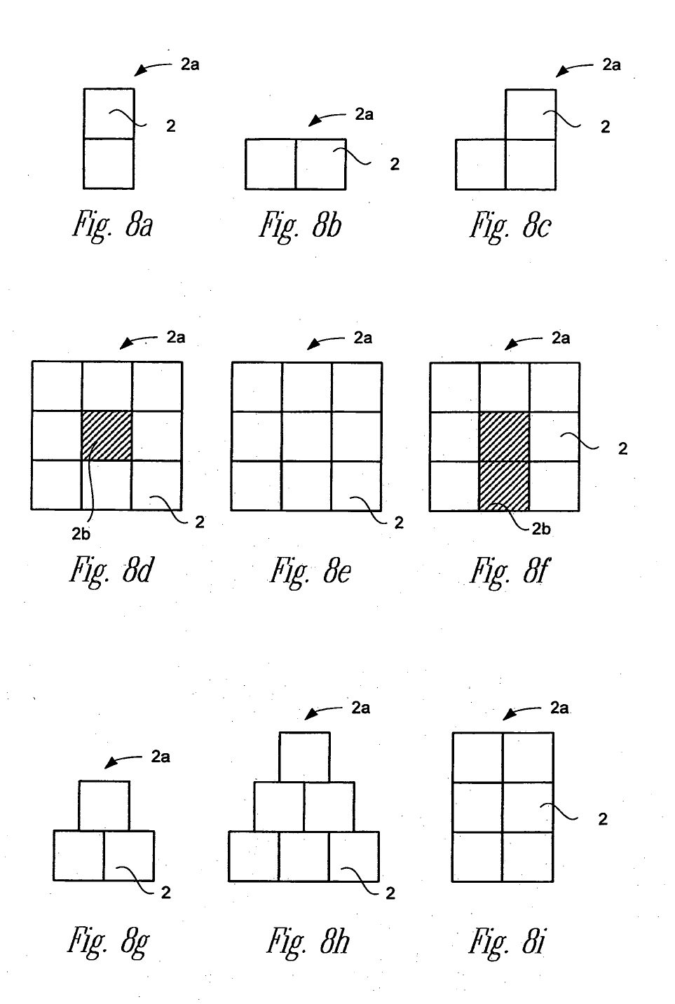

In the current embodiment, at least one of the controller 4 (FIG. 1) and output device 5 (FIG. 1) is located within the open region 7. The shell 3 may include a receptacle (not shown) for supplying “source” power to the controller 4, output device 5, and/or a plug for main power or power from additional cubes that are coupled to form an array 2a (FIGS. 8a-8i). A standard 16 gauge extension cord with ground plug may be used to supply the main power to the receptacle.

The display blocks 2 are designed to allow graphics (not shown) to span the open space 7 on one or both ends of the display block 2. Graphics may be attached, for example, using magnetic strips which adhere to the shell 3. A graphic may be sized relative to a single display block 2 or may be sized to span across multiple display blocks 2. Generally, translucent graphics are used such that when a light source within the open space 7 is activated (e.g., by a controller 4), the graphic is illuminated.

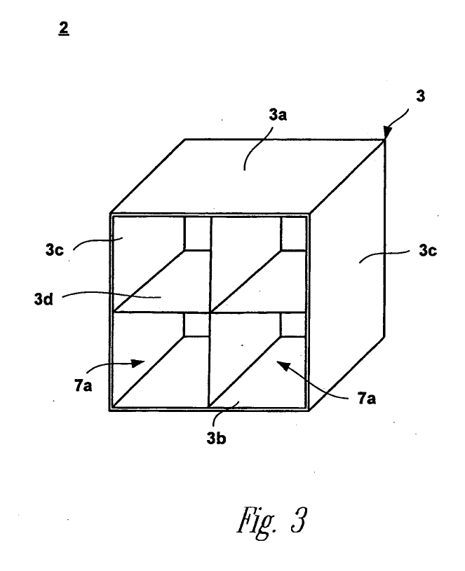

The display block 2 may also include a number of dividers structured to segment the open region 7 into a plurality of sections. FIG. 3, for example, shows a display block 2 that is divided into four sections 7a by dividers 3d. Each of at least some of the sections 7a may include an associated controller 4 and output device 5 (not shown in FIG. 3). Each output device 5 may be independently turned on and off by its associated controller 4. Graphics designed to span the open space 7 of one or more sections 7a may be attached to the display block 2.

The display block 2 is structured to couple with at least one other display block 2 to form a display block array 2a. FIGS. 8a-8i, which will be discussed in more detail below, illustrate several example arrangements of display block arrays 2a.

Although shown generally as being cube-shaped in FIGS. 2, 3 and 8a-8i, it is contemplated that the display block 2 may assume the form of other shapes while remaining within the scope of the present invention. The display block 2, for example and without limitation, may include three panels arranged in a triangular shape or may include a single rolled panel arranged in a cylindrical shape.

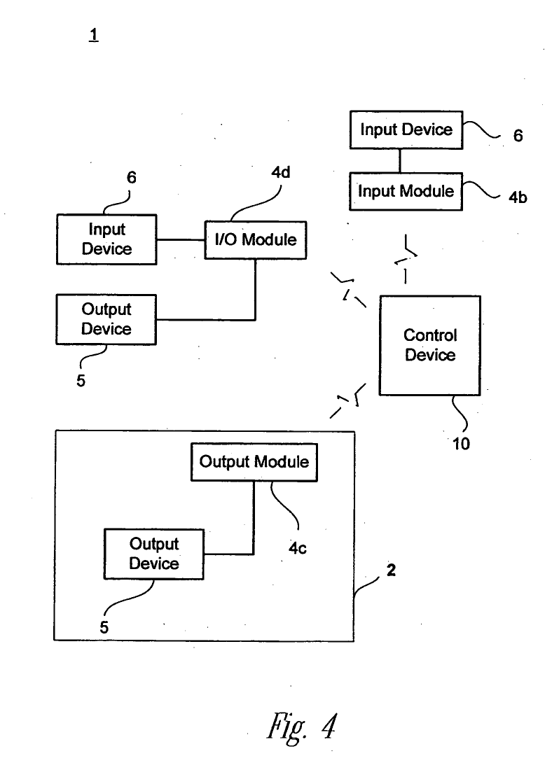

In the embodiment illustrated in FIG. 4, the display system 1 utilizes the ZigBee™ Alliance wireless communication standard. More specifically, the network coordinator (e.g., the control device 10) and the network devices (e.g., controller 4 (FIG. 1); a stand-alone input device; a stand-alone output device) communicate with each other using the ZigBee™ Alliance wireless communication standard. As shown in FIG. 4, the controllers 4 may include a ZigBee input module 4b (e.g., associated with an input device 6), a ZigBee output module 4c (e.g., associated with an output device 5), and a ZigBee input/output module 4d (e.g., associated with an input device 6 and an output device 5).

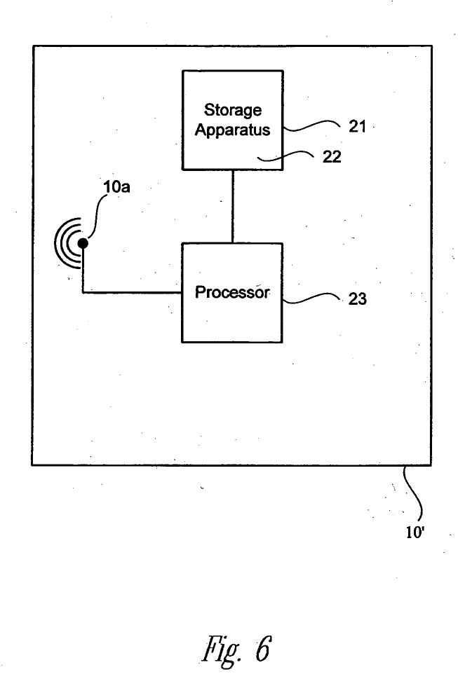

FIG. 5 is a more detailed illustration of a display system. More specifically, in the display system 1′ of FIG. 5, the control device is comprised of a server 10′ having (as shown in FIG. 6) a storage apparatus 21 with a number of routines 22 stored therein, and a processor 23 structured to execute at least one of the routines 22 to produce output information. As employed herein, the term “server” shall expressly include, but not be limited by, a base station; and/or a network coordinator.

The routines 22 may include, for example and without limitation, a wireless communication routine and an audio/video routine. The server 10′ is structured to integrate the wireless communication routine with the audio/video routine.

In one embodiment, the wireless communication routine includes a ZigBee I/O plug-in and the audio/video routine includes a multimedia editing software platform such as a non-linear video editor (NLE). In this embodiment, a user may create an audio/video sequence using the NLE. The user can then synchronize this audio/video sequence with one or more output devices using the ZigBee I/O plug-in to create an automated experience. For example, the user may create a video clip and soundtrack related to one or more products being displayed. This video clip and soundtrack can be integrated with ZigBee I/O plug-in so that when a customer approaches the motion sensor 6a, the video clip is output on video display 5d and the soundtrack is output on speaker 5e. At certain points designated by the user within the video clip and soundtrack, other output devices are activated. For instance, if the video clip and soundtrack reach a certain point where a particular product is being discussed, and that product is being displayed within display block 2, the user can designate that server 10′ communicate output information to the lighting ballast 4e such that display specific lighting 5b is activated to draw attention to that product.

In another embodiment, the wireless communication routine includes a ZigBee I/O routine and the audio/video routine includes a stream-file editor and a scripting interface. The stream-file editor is structured to create and edit stream files (e.g., video; audio; device settings). The scripting interface creates script files using these stream files as focal points for later execution. The server 10′ oversees the implementation and execution of the script files relative to the wireless communication routine.

The stream-file editor allows a user with basic knowledge of using a Graphical User Interface (GUI) (e.g., Windows® environment) to generate a stream file which can, for instance, be incorporated into a script file later in the development process. The stream-file editor typically generates a single stream file per use. This stream file is then stored in a stream file list. A stream file represents a static set of actions to be performed at a specific time, for example, a stream file may represent the following actions: “Dim the lights to 50% after 20 seconds, play the clip ‘Laughing.avi’ after 30 seconds, and turn off all the lights and video after 56 seconds”. A stream file may be employed to control any number of devices, but can only perform operations at a fixed time from when the stream file is initiated. Stream files allow the grouping of multiple devices to be used as input or output and, unlike simple files, allow for the formulation of multiple video and light ideas into a single idea.

The function of the scripting interface (also referred to as the “scripting GUI” herein) is to generate the script files that are executed by server 10′. The files are generated by the scripting GUI itself, which is designed to make it unnecessary for a user to learn the particular scripting language. By making the generation of the scripting language automatic, users only need to understand the basics of operating in a GUI environment. It is contemplated, however, that the script files may also be directly generated using the scripting language (i.e., without the scripting GUI).

The scripting files may contain a number of control structures and a number of stream files. Control structures may be arranged in a hierarchical manner, for instance nested within one another, such that certain control structures receive a different priority for execution. Stream files form the basis of the executable statements inside the control structures. As discussed above, stream files are created using the stream-file editor and stored within a stream file list.

To create a script file, a user creates a scripting outline which includes a number of control structures arranged in a hierarchical manner. A copy of a stream file may then be added inside one of the control structures. Adding a stream to a control structure, however, does not remove it from the stream file list. As a result, a copy of the same stream file can be inserted into multiple control structures. When fully completed, the scripting outline is then finalized. A finalization process converts the scripting outline into a script file which may be executed by server 10′.

The server 10′ oversees the implementation of the script files. The server 10′ continually updates to the specific stimuli of the environment around it, making the program adapt to fit the needs of its application. For example, if the motion sensor 6a detects a customer, the server 10′ may give execution priority to a particular script file and/or control structure (within that script file) such that a particular stream file (e.g., Dim the lights to 50% after 20 seconds, play the clip ‘Laughing.avi’ after 30 seconds, and turn off all the lights and video after 56 seconds”) is executed. The server 10′ then integrates the particular stream file with the wireless communications routine to provide the proper output information to the input/output devices. In the current embodiment, once the script files are created, the server 10′ can operate autonomously (i.e., without further user interaction) from the user.

By integrating the wireless communications routine with the audio/video routine (using, for example and without limitation, either embodiment discussed above), a unique customer experience can be created, complete with sights, sounds and scents. For example, the experience may begin when a customer approaches a motion sensor 6a or engages a touch screen (not shown) within display system 1′. From there, a number of actions can be initiated by the ZigBee I/O plug-ins, including, for example, playing an audio track on a speaker 5e of a surround sound system, dimming or brightening display specific lights 5b (e.g., via lighting ballast 4e) and/or overhead lighting 5c (e.g., via switch 4f), starting a video on a video display 5d or producing, with a scent generator 5a, a scent which correlates with the subject of the display system 1′. These actions may occur simultaneously, in sequence, or in any suitable combination depending on the desired effect.

The customer may be guided through the display system 1′ by a series of programmed actions, or may interact with the display system 1′ with an array of actions occurring based on specific input received from the customer via strategically placed sensors (e.g., motion sensor 6a). For example, if the motion sensor 6a detects a customer standing for a period of time near the display system 1′, a signal will be sent to the server 10′ by I/O Module 4d. The server 10′ may then communicate output information (e.g., audio/video information; control information) to the other components of the display system 1′. For example, the server 10′ may send control information to switch 4f causing the overhead lighting 5c to dim and may send audio/video information to the video display 5d and speaker 5e causing a prerecorded message to be played thereon. The overhead lighting 5c, display specific lighting 5b, and scent generator 5a may all be adjusted based on the control information communicated by the server 10′. It should be apparent that many combinations of inputs can be used to produce control information which is integrated with the audio/video information to allow for an infinite range of customer specific interactive physical environments.

It should be noted that display system 1′ may be adapted to interface with preexisting input, output, and control devices. A retail store, for instance, may employ a preexisting control system which includes a number of wireless switches 4f for controlling the operation of overhead lighting 5c. The server 10′ may be installed in the retail store and configured as a substitute for, or as a compliment to, the preexisting control system. Thus, the overhead lighting 5c as well as other devices (e.g., HVAC system; automatic doors) originally controlled by the preexisting control system may be incorporated into the unique customer experience as discussed above.

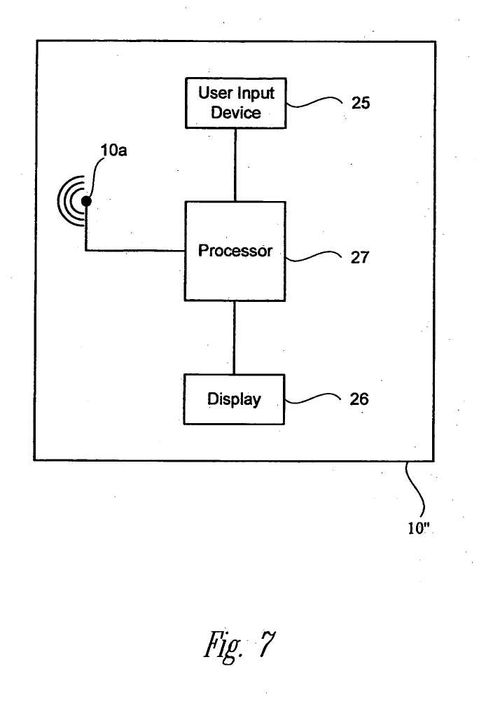

FIG. 7 shows another embodiment of the control device 10 for the display system 1 of FIG. 4. More specifically, the control device 10 may be a portable fob 10″ which includes a user input device 25, a display 26, and a processor 27 structured to generate the control information. The user input device 25, the display 26, and the processor 27 cooperate to enter the control information.

As employed herein, the term “fob” shall expressly include, but not be limited by, a portable wireless communicating device; handheld portable communicating device having a wireless communication port (e.g., without limitation, a handheld wireless device; a handheld personal computer (PC); a Personal Digital Assistant (PDA); a wireless network device; a wireless object that is directly or indirectly carried by a person; a wireless object that is worn by a person; a wireless object that is placed on or coupled to a household object (e.g., a refrigerator; a table); a wireless object that is coupled to or carried by a personal object (e.g., a purse; a wallet; a credit card case); a portable wireless object; and/or a handheld wireless object.

The fob 10″ may be used, for example, by a vendor giving a presentation to one or more customers standing near the display system 1. The vendor, wishing to draw attention to a specific display block 2 can manipulate the input device 25 such that control information is generated causing a controller 4 to activate its associated output device 5 (e.g., a display specific light source). The vendor can also manipulate the input device 25 such that control information is generated causing the controller 4 to deactivate its associated output device 5 while causing another controller 4 to activate its associated output device 5 and/or input device 6. It should be noted that non-integrated audio/video information may also be activated using the fob 10″. For example, the fob 10″ may be used to generate control information which causes a controller 4 to activate/deactivate an output device 5, such as a DVD player, connected to a video display.

FIGS. 8a-8i illustrate example array arrangements of two or more of the display blocks 2. The display blocks 2 are designed to couple in various arrangements and may be stacked one on top of the other and/or one beside the other. Although FIGS. 8a- 8i illustrate arrays 2a having a height or width of no more than three (3) display blocks, larger arrays 2a are contemplated. Furthermore, other arrangements may be configured while remaining within the scope of the present invention.

As illustrated in FIGS. 8d and 8f, a substitute block 2b may be used in place of one or more of the display blocks 2 in a display block array 2a. For example, a media display block 2a can be utilized in any configuration by simply exchanging one or multiple display blocks 2 for the media display block 2b. The media display block 2a may include, for example, a plasma screen display which can be configured to play a DVD with imbedded functionality to control the surrounding display blocks 2 as well as any other components of the display system 1.

In the embodiments illustrated in FIGS. 8a- 8i, the display blocks 2 are of a standard size which facilitates setup and transportation, graphics change out, multiple arrangements of graphics, expansion to multiple displays, and control of the lighting to highlight specific graphics under user control. It will be appreciated, however, that different or nonstandard sizes may be employed.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A display system, comprising:
a number of display blocks, at least one of said display blocks comprising:
a shell structured to define an open region;
a controller with a wireless transceiver structured to receive control information; and
an output device structured to be turned on and off by said controller in response to said control information,
wherein at least one of said controller and said output device is located within said open region; and
a control device with a wireless transceiver structured to communicate said control information to the wireless transceiver of said controller.

2. The display system of claim 1 wherein said controller comprises at least one of an input module, an output module, and an input/output module.

3. The display system of claim 2 wherein said controller comprises at least one of lighting ballast and a switch.

4. The display system of claim 1 wherein said output device is one of a light source, a scent generator, a thermostat, a motor, a video display, a speaker, and a projector.

5. The display system of claim 1 wherein said control device comprises a server including:
a storage medium having a number of routines stored therein; and
a processor structured to execute at least one of said routines and produce said control information.

6. The display system of claim 1 wherein said control device comprises a portable fob including a user input device, a display, and a processor structured to generate said control information.

7. The display system of claim 6 wherein said user input device, said display, and said processor cooperate to enter said control information.

8. The display system of claim 1 wherein said shell further comprises:
a first panel;
a second panel; and
a third panel coupling said first panel to said second panel,
wherein said open region is disposed between said first panel, said second panel, and said third panel.

9. The display system of claim 1 wherein a first one of said display blocks is structured to couple with at least a second one of said display blocks to form a display block array.

10. The display system of claim 1 wherein at least one of said display blocks further comprises a divider structured to segment a corresponding one of said at least one of said display blocks into a plurality of sections.

11. The display system of claim 10 wherein each of at least some of said sections includes an associated controller and an output device structured to be turned on and off by said associated controller.

12. The display system of claim 1 wherein the wireless transceiver of said control device is structured to communicate with the wireless transceiver of the controller associated with said output device using a ZigBee™ Alliance standard.

13. A display system comprising:
a number of input devices structured to generate input information, each of at least some of said input devices being associated with an input module including a transceiver structured to wirelessly communicate said input information;
a server including a transceiver, said server being structured to receive said input information, to execute a number of routines for generating output information, and to wirelessly communicate said output information, wherein said output information includes audio/video information produced by execution of a audio/video routine and control information produced by execution of a wireless communication routine; and
a number of controllers structured to turn on and off a number of output devices, each of at least some of said controllers being associated with an output module and including a transceiver structured to wirelessly receive said control information.

14. The display system of claim 13 wherein each of at least some of said output devices includes an associated display block.

15. The display system of claim 14 wherein a first one of said display blocks is structured to couple with at least a second one of said display blocks to form a display block array.

16. The display system of claim 13 wherein at least one of said input devices comprises one of a keyboard, a mouse, a motion sensor, a biometric reader, a microphone, a camera, and a vibration sensor.

17. The display system of claim 13 wherein at least one of said output devices comprises one of a light source, a scent generator, a thermostat, a motor, a video display, a speaker, and a projector.

18. The display system of claim 13 wherein said server is structured to wirelessly communicate with at least one of said input module, and said output module using a ZigBee™ Alliance standard.

19. A display media server comprising:
a storage apparatus having a number of routines stored therein;
a processor structured to execute at least some of said routines and produce output information in response to a user input, said output information including audio/video information produced by execution of an audio/video routine and control information produced by execution of a wireless communication routine; and
a transceiver structured to wirelessly communicate said output information including said audio/video information and said control information to a number of output devices.

20. The display media server of claim 19 wherein said transceiver is structured to wirelessly receive said user input from an input device.

21. The display media server of claim 20 wherein said input device includes at least one of a keyboard, a mouse, a motion sensor, a biometric reader, a microphone, a camera, and a vibration sensor.

22. The display media server of claim 19 wherein said output devices include at least one of a light source, a scent generator, a thermostat, a motor controller, a video display, a speaker, and a projector.

23. A display system, comprising:
a number of display blocks, at least one of said display blocks comprising:
a shell structured to define an open region;
a controller with a wireless transceiver structured to receive control information; and
an output device structured to be turned on and off by said controller in response to said control information, wherein at least one of said controller and said output device is located within said open region; and
a control device with a wireless transceiver structured to communicate said control information to the wireless transceiver of said controller;
an input device associated with another controller, said another controller with another wireless transceiver structured to communicate input information to the wireless transceiver of said control device.

24. The display system of claim 23 wherein said input device is one of a keyboard, a mouse, a motion sensor, a biometric reader, a microphone, a camera, and a vibration sensor.

25. The display system of claim 23 wherein the wireless transceiver of said control device is structured to communicate with at least one of said wireless transceiver of said controller associated with said output device and the another wireless transceiver of the another controller associated with said input device using a ZigBee™ Alliance standard.
